(19) United States
(12) Patent Application Publication
(10) Pub. No.: US 2016/0227347 A1
(43) Pub. Date: Aug. 4, 2016

(54) Method and Device of Simultaneous Transmission of Audio Signal and Control Signal

(71) Applicant: Shenzhen Reasoningsoft Co., Limited, Shenzhen (CN)

(72) Inventor: Qixiang FENG, Shenzhen (CN)

(73) Assignee: Shenzhen Reasoningsoft Co., Limited

(21) Appl. No.: 14/610,591

(22) Filed: Jan. 30, 2015

(51) Int. Cl. H04W 4/00

(52) U.S. Cl. CPC H04W 4/008

(57) ABSTRACT

A wireless communication system includes a first electronic device and a second electronic device. The first electronic device includes a transmitting BLUETOOTH module, a memory unit for storing at least one audio file and a control signal, and a first processing unit electrically connecting to the transmitting BLUETOOTH module and the memory unit. The second electronic device includes a receiving BLUETOOTH module, an audio device, a controlled device, and a second processing unit electrically connected to the receiving BLUETOOTH module, the audio device and the controlled device. In the first electronic device, the audio file is arranged to be converted to an audio frequency signal stream and the control signal is arranged to be modulated into the audio frequency signal stream to form a stream of audio frequency chopper signals which are then wirelessly transmitted to the second electronic device through BLUETOOTH technology.

### BACKGROUND OF THE PRESENT INVENTION

1. Field of Invention

The present invention relates to a wireless technology, and more particularly to a wireless communication system and method which utilize BLUETOOTH wireless technology to wirelessly transmit both audio and control signals.

2. Description of Related Arts

BLUETOOTH modules have widely been used for wirelessly transmitting audio signals over a relatively short distance. A conventional BLUETOOTH module may be installed in an electronic device, such as a smartphone, so that when the smartphone is activated to play music, audio signals may be transmitted from that electronic device to another electronic device through the BLUETOOTH module. As such, the music stored in the first electronic device may be played by the second electronic device which is at a distance from the first electronic device.

A major disadvantage of a conventional BLUETOOTH module mentioned above is that such module can only transmit audio signals wirelessly. Very often however, when audio signals are being transmitted, transmission of some sorts of control signals are also desirable because the control signals may initiate a wide variety of auxiliary functions, such as producing various lighting effects.

Thus, there is a need to develop a BLUETOOTH module which is capable of transmitting both audio and control signals.

### SUMMARY OF THE PRESENT INVENTION

An objective of the present invention is to provide a wireless communication system and method which utilize BLUETOOTH wireless technology to wirelessly transmit both audio and control signals.

Another objective of the present invention is to provide a wireless communication system which comprises a first electronic device and a second electronic device, wherein audio signals and control signals stored in said first electronic device can be converted and modulated into a single stream of audio frequency chopper signals which is wirelessly transmitted to the second electronic device.

Another objective of the present invention is to provide a method of wirelessly transmitting audio frequency and control signals through BLUETOOTH technology.

In one aspect of the present invention, it provides a wireless communication system, comprising:

a first electronic device comprising a transmitting BLUETOOTH module, a memory unit for storing at least one audio file and a control signal, and a first processing unit electrically connecting to the transmitting BLUETOOTH module and the memory unit; and

a second electronic device comprising a receiving BLUETOOTH module, an audio device, a controlled device, and a second processing unit electrically connected to the receiving BLUETOOTH module, the audio device and the controlled device;

wherein in the first electronic device, the audio file is arranged to be converted to an audio frequency signal stream and the control signal being arranged to be modulated into the audio frequency signal stream to form a stream of audio frequency chopper signals, the stream of audio frequency chopper signals being wirelessly transmitted to the second electronic device through the transmitting BLUETOOTH module and the receiving BLUETOOTH module, wherein in the second electronic device, the stream of audio frequency chopper signals are demodulated back into the audio frequency signals stream and the control signal, the audio frequency signals stream being processed by the second processing unit which drives the audio device to deliver audible sound according to the audio frequency signal stream, the control signal being processed by the second processing unit which drives the controlled device to operate.

In another aspect of the present invention, it provides a method of wirelessly transmitting audio and control signals from a transmitting BLUETOOTH module of a first electronic device to a receiving BLUETOOTH module of a second electronic device comprises the steps of:

(a) converting an audio file stored in the first electronic device into an audio frequency signal stream;

(b) modulating a control signal stored in the first electronic device into the audio signal stream by using phase-shift keying to form a stream of audio frequency chopper signals;

(c) wirelessly transmitting the stream of the audio frequency chopper signals to the second electronic device by using the receiving BLUETOOTH module;

(d) demodulating the stream of audio frequency chopper signals by the second electronic device to form a stream of control signals; and

(e) transmitting the control signals to a controlled device of the second electronic device for controlling an operation thereof.

### BRIEF DESCRIPTION OF THE DRAWINGS

FIG. 1A is a block diagram of a first electronic device of a wireless communication system according to a preferred embodiment of the present invention.

FIG. 1B is a block diagram of a second electronic device of the wireless communication system according to the preferred embodiment of the present invention

FIG. 2 is a schematic diagram of a lighting control panel as controlled by the wireless communication system according to the preferred embodiment of the present invention.

FIG. 3 schematic diagram of a method of wirelessly transmitting audio frequency signals and control signals through BLUETOOTH technology according to the preferred embodiment of the present invention.

### DETAILED DESCRIPTION OF THE PREFERRED EMBODIMENT

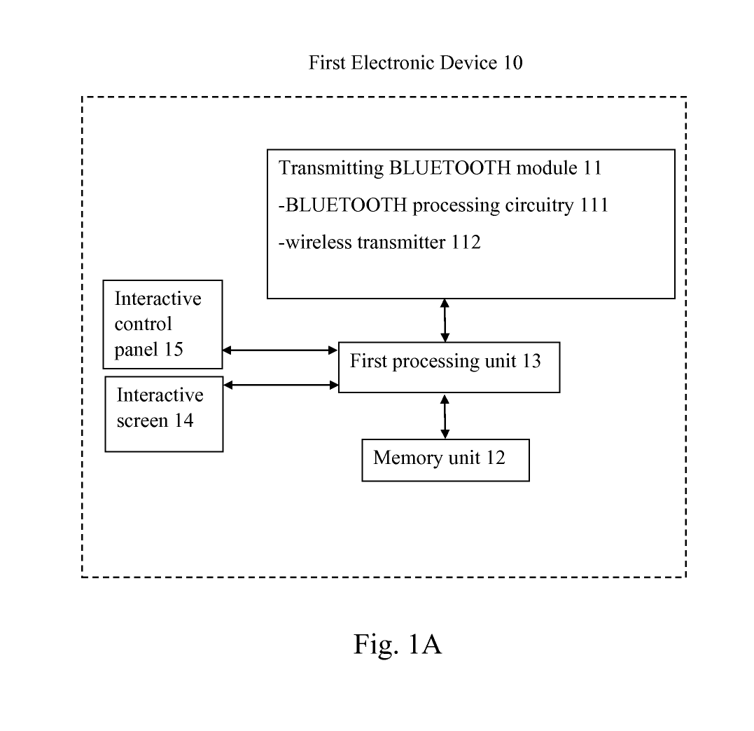

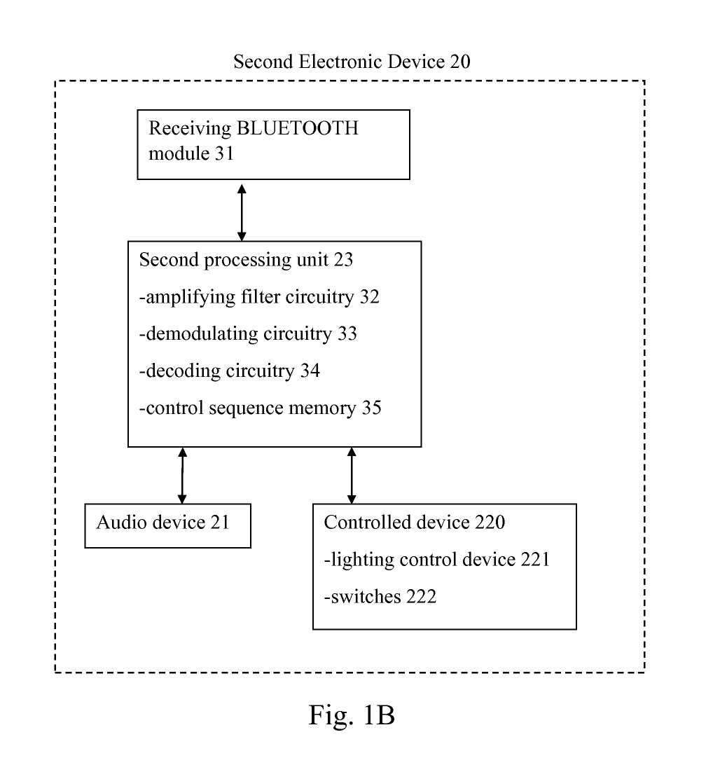

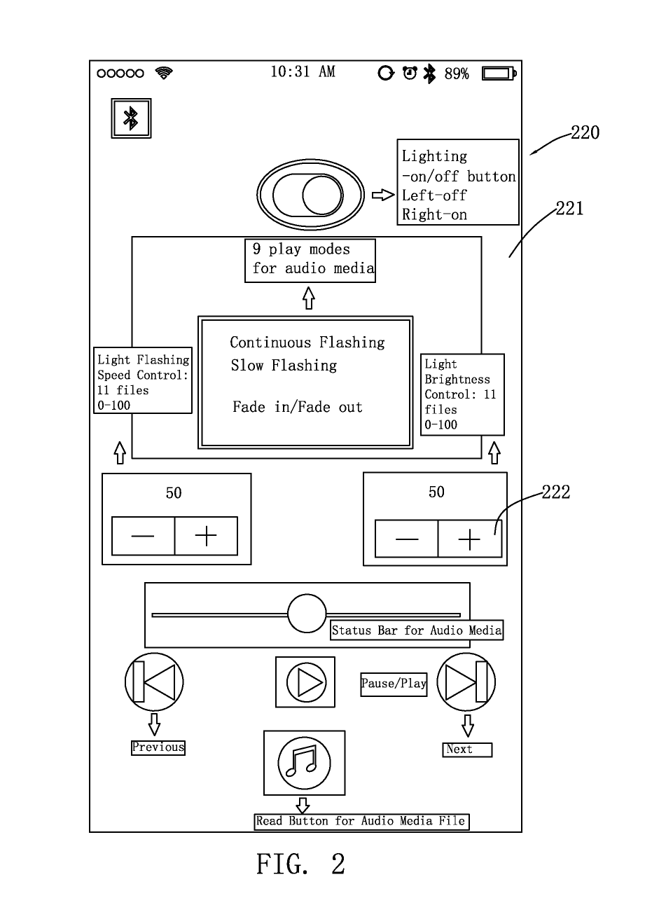

Referring to FIG. 1A to FIG. 1B and FIG. 2 of the drawings, a wireless communication system according to a preferred embodiment of the present invention is illustrated. Broadly, the wireless communication system comprises a first electronic device 10, and a second electronic device 20.

The first electronic device 10 comprises a transmitting BLUETOOTH module 11, a memory unit 12 for storing at least one audio file and a control signal, and a first processing unit 13 electrically connecting to the transmitting BLUETOOTH module 11 and the memory unit 12.

The second electronic device 20 comprises a receiving BLUETOOTH module 31, an audio device 21, a controlled device 220, and a second processing unit 23 electrically connected to the receiving BLUETOOTH module 31, the audio device 21 and the controlled device 220.

In the first electronic device 10, the audio file is arranged to be converted to an audio frequency signal stream and the control signal is arranged to be modulated into the audio frequency signal stream to form a stream of audio frequency chopper signals. This stream of audio frequency chopper signals is arranged to be wirelessly transmitted to and received by the second electronic device 20 through the transmitting BLUETOOTH module 11 and the receiving BLUETOOTH module 200 respectively.

In the second electronic device 20, the stream of audio frequency chopper signals are demodulated back into the audio frequency signals stream and the control signal, wherein the audio frequency signals stream is processed by the second processing unit 23 which drives the audio device 21 to deliver audible sound according to the audio frequency signal stream. On the other hand, the control signal is processed by the second processing unit 23 which drives the controlled device 220 to operate for producing a predetermined non-audio effect.

According to the preferred embodiment of the present invention, the first electronic device 10 is preferably a mobile telecommunication device, such as a smartphone, which is programmed to convert the audio file and the control signal into the stream of audio frequency chopper signals. The program may be executed through interactive devices provided on the first electronic device 10. Accordingly, the first electronic device 10 may further comprise an interactive screen 14 and an interactive control panel 15 provided on the first electronic device 10 for allowing a user to control an operation thereof. The program may be stored in the first electronic device 10 in the form of a specific application, which may be executed to transform the audio file and the control signal into the stream of audio frequency chopper signals.

The transmitting BLUETOOTH module 11 of the first electronic device 10 comprises an audio frequency BLUETOOTH processing circuitry 111 and a wireless transmitter 112 electrically connected to the audio frequency BLUETOOTH processing circuitry 111 for wireless transmitting the stream of audio frequency chopper signals through BLUETOOTH technology.

The first processing unit 13 may be program to convert the audio file into the audio frequency signal stream and to modulate the control signal into the audio frequency signal stream through the use of binary phase-shift keying, or other phase-shift keying techniques. The audio frequency chopper signals is then transmitted to the BLUETOOTH processing circuitry 111 which controls the wireless transmitter 112 to wireless transmit the audio frequency chopper signals to the second electronic device 20. The program is stored in the memory unit 12 of the first electronic device 10.

The receiving BLUETOOTH module 31 of the second electronic device 20 is arranged to receive the wireless signal from the first electronic device 10. The second processing circuitry 23 comprises an amplifying filter circuitry 32 and a demodulating circuitry 33 electrically connected to the amplifying filter circuitry 32, wherein the amplifying filter circuitry 32 is arranged to amplify and filter the audio frequency chopper signals transmitted from the first electronic device 10. The demodulating circuitry 33 is arranged to demodulate he audio frequency chopper signals back into an audio frequency signal and the control signals. The second processing circuitry 23 further comprises a decoding circuitry 34 electrically connected to the demodulating circuitry 33, and a control sequence memory 35 electrically connected to the decoding circuitry 34. The decoding circuitry 34 is arranged to decode the control signals from the demodulating circuitry 33, while the control sequence memory 35 is arranged to store control sequence of the control signals.

The control signals are then transmitted to the controlled device 220 for performing auxiliary functions such as controlling switching of certain lighting fixtures. For example, as shown in FIG. 2 of the drawings, the controlled device 220 may be controlled by a lighting control panel 221 having a plurality of switches 222 for controlling several parameters of lighting effects. The control signals may be transmitted to the controlled device 220 so that the lighting control panel 221 is digitally controlled by the control signal. As such, the lighting effects can be controlled by the control signals initiated from the first electronic device 10 through BLUETOOTH technology. With the present invention, BLUETOOTH technology may be used to wirelessly transmit both audio frequency signals and control signals.

It is worth mentioning that the controlled device 220 of the second electronic device 20 may be embodied as a wide variety of apparatuses which may perform a wide range of functions, especially those having complementary effects to audio playing. Examples may include lighting effects or water effects. It is a device controlled by the first electronic device 10.

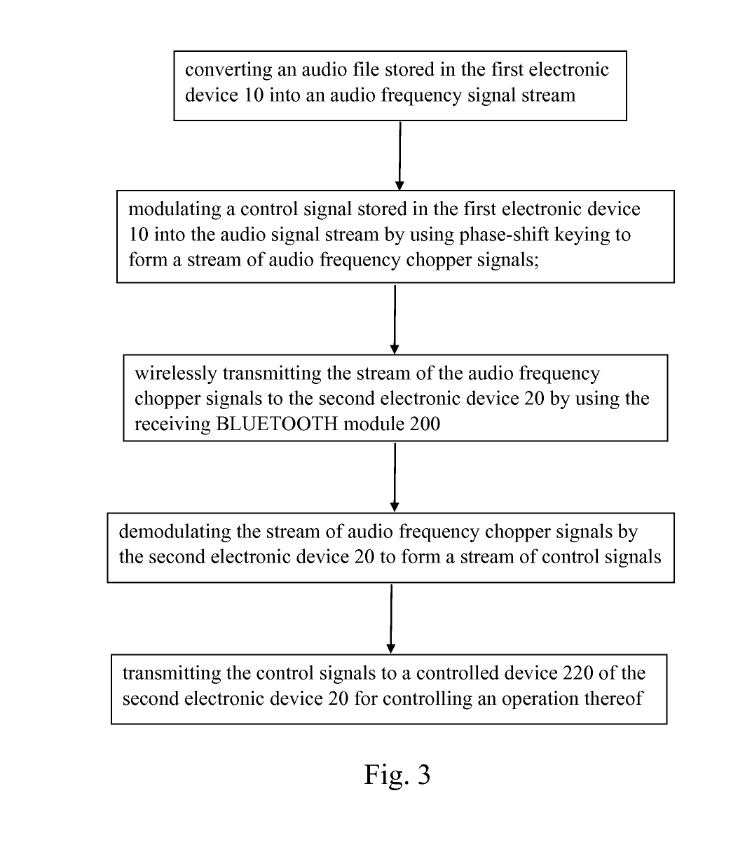

Referring to FIG. 3 of the drawings, a method of wirelessly transmitting audio and control signals from a transmitting BLUETOOTH module 11 of a first electronic device 10 to a receiving BLUETOOTH module 200 of a second electronic device 20 comprises the steps of:

(a) converting an audio file stored in the first electronic device 10 into an audio frequency signal stream;

(b) modulating a control signal stored in the first electronic device 10 into the audio signal stream by using phase-shift keying to form a stream of audio frequency chopper signals;

(c) wirelessly transmitting the stream of the audio frequency chopper signals to the second electronic device 20 by using the receiving BLUETOOTH module 31;

(d) demodulating the stream of audio frequency chopper signals by the second electronic device 20 to form a stream of control signals; and

(e) transmitting the control signals to a controlled device 220 of the second electronic device 20 for controlling an operation thereof.

The present invention, while illustrated and described in terms of a preferred embodiment and several alternatives, is not limited to the particular description contained in this specification. Additional alternatives or equivalent components could also be used to practice the present invention.

1. A wireless communication system, comprising:
a mobile telecommunication device comprising a transmitting BLUETOOTH module, a memory unit for storing at least one audio file and a control signal, and a first processing unit electrically connecting to said transmitting BLUETOOTH module and said memory unit; and
a second electronic device comprising a receiving BLUETOOTH module, an audio device, a controlled device, and a second processing unit electrically connected to said receiving BLUETOOTH module, said audio device and said controlled device;
wherein in said mobile telecommunication device, said audio file is arranged to be converted to an audio frequency signal stream and said control signal being arranged to be modulated into said audio frequency signal stream through binary phase-shift keying to form a stream of audio frequency chopper signals, said stream of audio frequency chopper signals being wirelessly transmitted to said second electronic device through said transmitting BLUETOOTH module and said receiving BLUETOOTH module, wherein in said second electronic device, said stream of audio frequency chopper signals are demodulated back into said audio frequency signals stream and said control signal, said audio frequency signals stream being processed by said second processing unit which drives said audio device to deliver audible sound according to said audio frequency signal stream, said control signal being processed by said second processing unit which drives said controlled device to operate for producing a non-audio effect.

2. (canceled)

3. The wireless communication system, as recited in claim 1, wherein said mobile telecommunication device further comprise an interactive screen and an interactive control panel provided on said mobile telecommunication device for allowing a user to control an operation thereof.

4. (canceled)

5. The wireless communication system, as recited in claim 1, wherein said transmitting BLUETOOTH module of said mobile telecommunication device comprises an audio frequency BLUETOOTH processing circuitry and a wireless transmitter electrically connected to said audio frequency BLUETOOTH processing circuitry for wirelessly transmitting said stream of audio frequency chopper signals to said second electronic device.

6. The wireless communication system, as recited in 3, wherein said transmitting BLUETOOTH module of said mobile telecommunication device comprises an audio frequency BLUETOOTH processing circuitry and a wireless transmitter electrically connected to said audio frequency BLUETOOTH processing circuitry for wirelessly transmitting said stream of audio frequency chopper signals to said second electronic device.

7-9. (canceled)

10. The wireless communication system, as recited in claim 3, wherein said second processing circuitry comprises an amplifying filter circuitry and a demodulating circuitry electrically connected to said amplifying filter circuitry.

11. The wireless communication system, as recited in claim 5, wherein said second processing circuitry comprises an amplifying filter circuitry and a demodulating circuitry electrically connected to said amplifying filter circuitry.

12. The wireless communication system, as recited in claim 6, wherein said second processing circuitry comprises an amplifying filter circuitry and a demodulating circuitry electrically connected to said amplifying filter circuitry.

13. The wireless communication system, as recited in claim 10, wherein said second processing circuitry further comprises a decoding circuitry electrically connected to said demodulating circuitry, and a control sequence memory electrically connected to said decoding circuitry.

14. The wireless communication system, as recited in claim 11, wherein said second processing circuitry further comprises a decoding circuitry electrically connected to said demodulating circuitry, and a control sequence memory electrically connected to said decoding circuitry.

15. The wireless communication system, as recited in claim 12, wherein said second processing circuitry further comprises a decoding circuitry electrically connected to said demodulating circuitry, and a control sequence memory electrically connected to said decoding circuitry.

16. A method of wirelessly transmitting audio and control signals from a transmitting BLUETOOTH module of a mobile telecommunication device to a receiving BLUETOOTH module of a second electronic device comprises said steps of:
(a) converting an audio file stored in said mobile telecommunication device into an audio frequency signal stream;
(b) modulating a control signal stored in said mobile telecommunication device into said audio signal stream by using phase-shift keying to form a stream of audio frequency chopper signals;
(c) wirelessly transmitting said stream of said audio frequency chopper signals to said second electronic device by using said receiving BLUETOOTH module;
(d) demodulating said stream of audio frequency chopper signals by said second electronic device to form a stream of control signals; and
(e) transmitting said control signals to a controlled device of said second electronic device for controlling an operation thereof.

17. (canceled)

18. The method, as recited in claim 16, wherein in said step (d), said second electronic device comprises an amplifying filter circuitry and a demodulating circuitry electrically connected to said amplifying filter circuitry.

19. (canceled)

20. The method, as recited in claim 18, wherein said transmitting BLUETOOTH module of said mobile telecommunication device comprises an audio frequency BLUETOOTH processing circuitry and a wireless transmitter electrically connected to said audio frequency BLUETOOTH processing circuitry for wirelessly transmitting said stream of audio frequency chopper signals to said second electronic device.
